(19) United States
(12) Patent Application Publication
(10) Pub. No.: US 2008/0206622 A1
(43) Pub. Date: Aug. 28, 2008

(54) Sealing member for fuel cell, method for producing the same and separator for fuel cell

(76) Inventor: Naoki Mitsuta, Saitama (JP)

Correspondence Address: ARENT FOX LLP, 1050 CONNECTICUT AVENUE, N.W., SUITE 400, WASHINGTON, DC, 20036, US

(21) Appl. No.: 11/802,778

(22) Filed: May 24, 2007

(30) Foreign Application Priority Data
Jun. 6, 2006 (JP) 2006-157538

(51) Int. Cl. H01M 2/08

(52) U.S. Cl. 429/35

(57) ABSTRACT

A sealing member for a fuel cell of the present invention includes a resin forming a matrix phase, and particles which are formed of rubber-like elastic body and dispersed in the resin. The sealing member exhibits acid resistance due to the resin, as well as elasticity due to the elastic particles, which gives excellent sealing property to the sealing member. Since acid resistance is steadily provided by the resin, unlike the conventional sealing member, the sealing member does not require expensive fluororubber and can be produced at a reduced cost.

### CROSS-REFERENCE TO RELATED APPLICATIONS

This application claims the foreign priority benefit under Title 35, United States Code, section 119 (a)-(d), of Japanese Patent Application No. 2006-157538, filed on Jun. 6, 2006 in the Japan Patent Office, the disclosure of which is herein incorporated by reference in its entirety.

### BACKGROUND OF THE INVENTION

1. Field of the Invention

The present invention relates to a sealing member for a fuel cell which seals a separator and a membrane electrode assembly or seals two separators of a fuel cell, a method for producing the same, and a separator for a fuel cell.

2. Description of the Related Art

Conventionally, between a separator and a membrane electrode assembly or between two adjacent separators of a fuel cell, a sealing member is disposed. In general, as a solid polymer electrolyte membrane used in the fuel cell deteriorates, water generated upon generating electric power by the fuel cell becomes more acidic. Therefore, as a sealing member, fluororubber which has excellent acid resistance has been used. However, fluororubber is expensive, and in order to provide a cost-saving sealing member, there has been proposed a sealing member in which a surface of silicone rubber is covered with fluororubber (see, for example, Japanese unexamined patent application laid-open specification No. 2004-55428, paragraphs 0007, 0025 and FIG. 1).

Since the surface of the sealing member is covered with fluororubber, the sealing member exhibits acid resistance, and since an inside of the sealing member is made of silicone rubber, a production cost can be reduced as compared with the sealing member made exclusively of fluororubber.

However, there is a room for reducing the cost of this sealing member, since the sealing member still uses fluororubber. In addition, the sealing member has a double-layer structure composed of silicone rubber and fluororubber, which requires extra production steps and examination of adhesive compatibility between the layers. Therefore, the sealing member has a problem of complicated production process.

Accordingly, it would be desirable to provide a sealing member for a fuel cell that exhibits acid resistance and is produced easily at a reduced cost, and a method for producing the same and a separator including the sealing member for a fuel cell.

### SUMMARY OF THE INVENTION

In one aspect of the present invention, there is provided a sealing member for a fuel cell including a resin forming a matrix phase, and particles which are formed of rubber-like elastic body and dispersed in the resin.

In another aspect of the present invention, there is provided a method for producing a sealing member for a fuel cell, including: a first step of heat-mixing a resin and particles formed of rubber-like elastic body to obtain a resin compound; and a second step of injection molding of the resin compound into a mold.

In still another aspect of the present invention, there is provided a separator for a fuel cell including a metal part in a shape of a plate provided with a gas flow passage on at least one side thereof, and a resin part that has a sealing part formed of a protruding portion and is attached to the metal part, wherein the resin part includes a resin forming a matrix phase and particles formed of rubber-like elastic body dispersed in the resin.

### BRIEF DESCRIPTION OF THE DRAWINGS

The various aspects, other advantages and further features of the present invention will become more apparent by describing in detail illustrative, non-limiting embodiments thereof with reference to the accompanying drawings.

FIG. 1 is a perspective view of a fuel cell in which a separator according to one embodiment is used.

FIG. 2 is an exploded perspective view showing a stacking

FIG. 10 is a schematic diagram showing a sectional view of a mold used for production of a separator.

FIG. 11 is a schematic diagram showing a fuel cell using a sealing member for a fuel cell according to one embodiment.

FIG. 12A is a perspective view of a sealing member for a fuel cell according to one embodiment; FIG. 12B is a sectional view taken along the line A-A′ of FIG. 12A; and FIG. 12C is an enlarged view of a portion B in FIG. 12B.

FIG. 13 shows a separator according to another embodiment, and is a plan view of a separator disposed on an anode side, seen from a membrane electrode assembly side.

FIG. 14 is a schematic diagram of a test device used for seal performance evaluation test on sealing members of Examples and Comparative Examples.

### DETAILED DESCRIPTION OF THE EXEMPLARY EMBODIMENTS

Embodiments of the present invention will be described in detail below with reference to the drawings. It should be noted that, in FIGS. 4A, 4B, 7A and 7B, some lines showing a depth dimension are omitted for convenience; and in FIGS. 8A-8C, some lines showing the depth dimension are shown with dotted lines, while some lines showing the depth dimension are omitted for convenience.

First, a separator will be explained along a description of a fuel cell in which the separator of the present invention is used.

### (Fuel Cell)

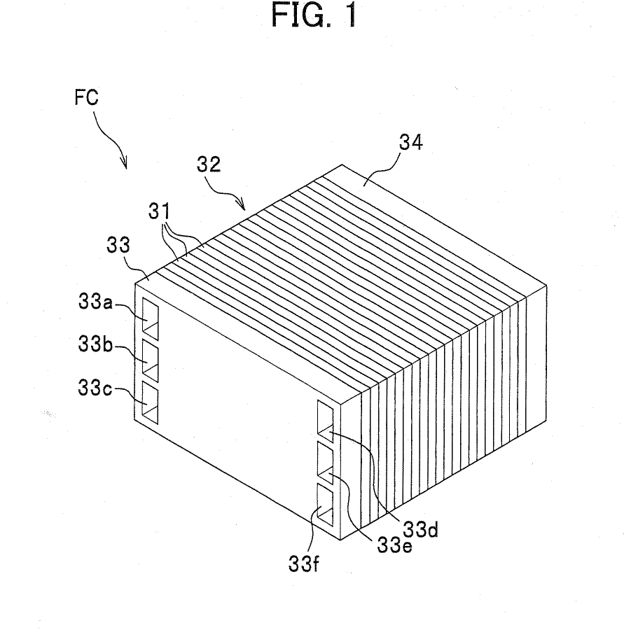

As shown in FIG. 1, a fuel cell FC has a manifold structure inside and includes a stacked body 32 formed of a plurality of single cells 31 stacked on one another.

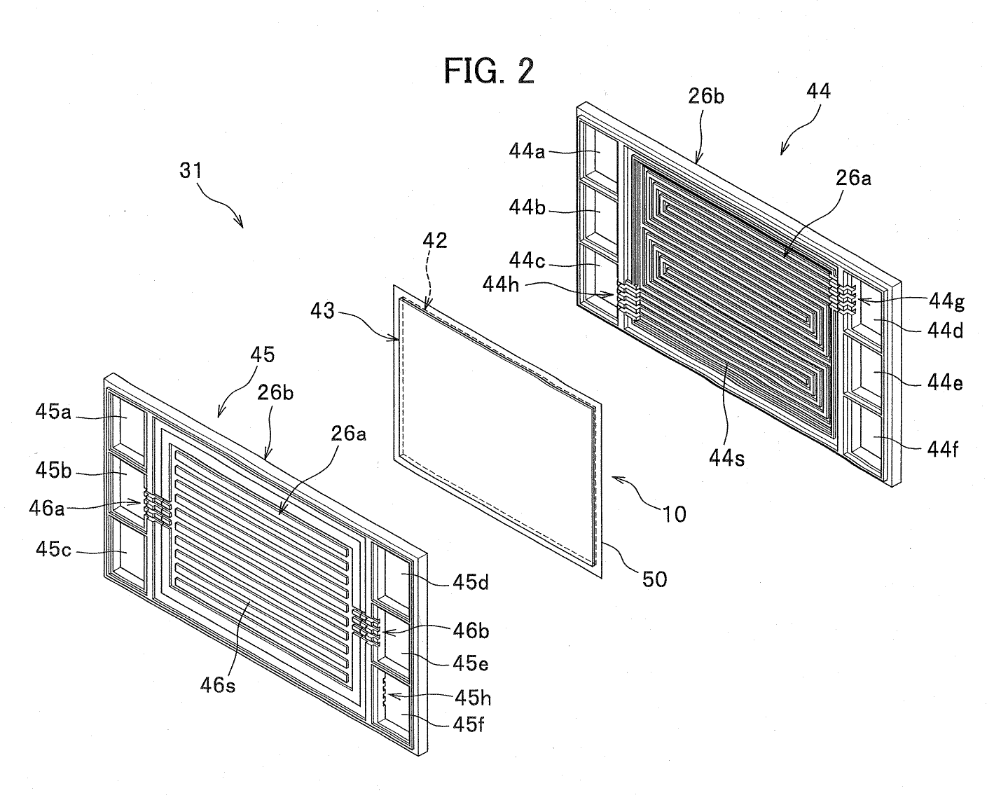

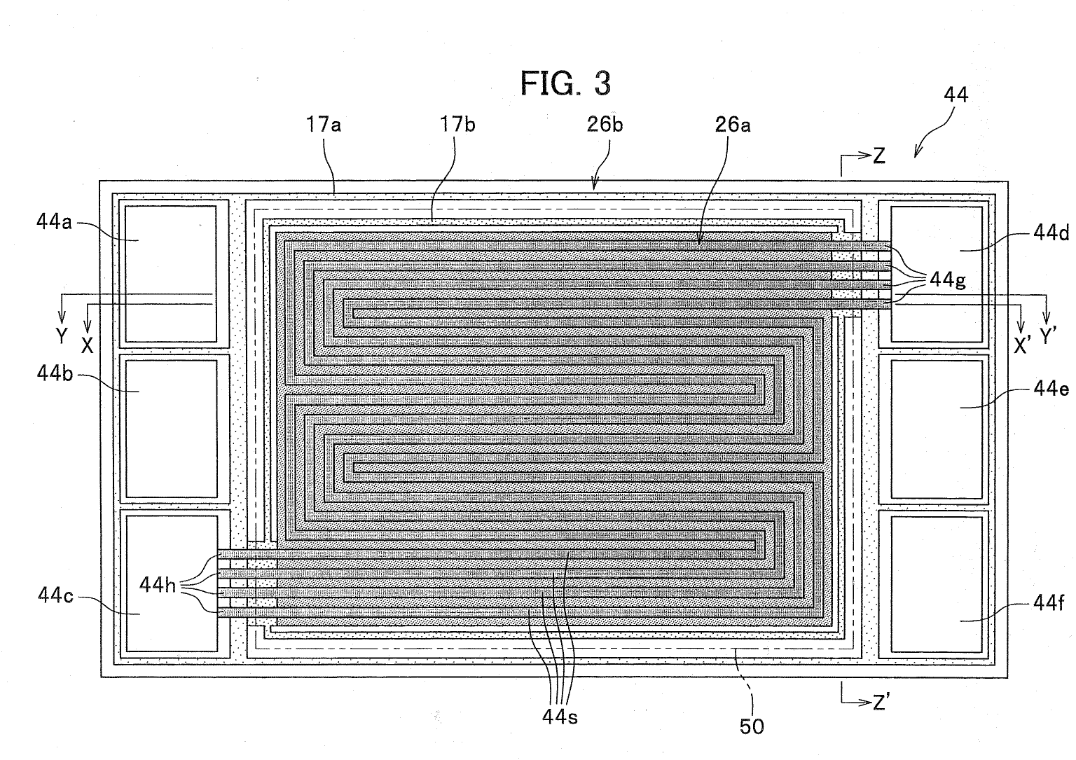

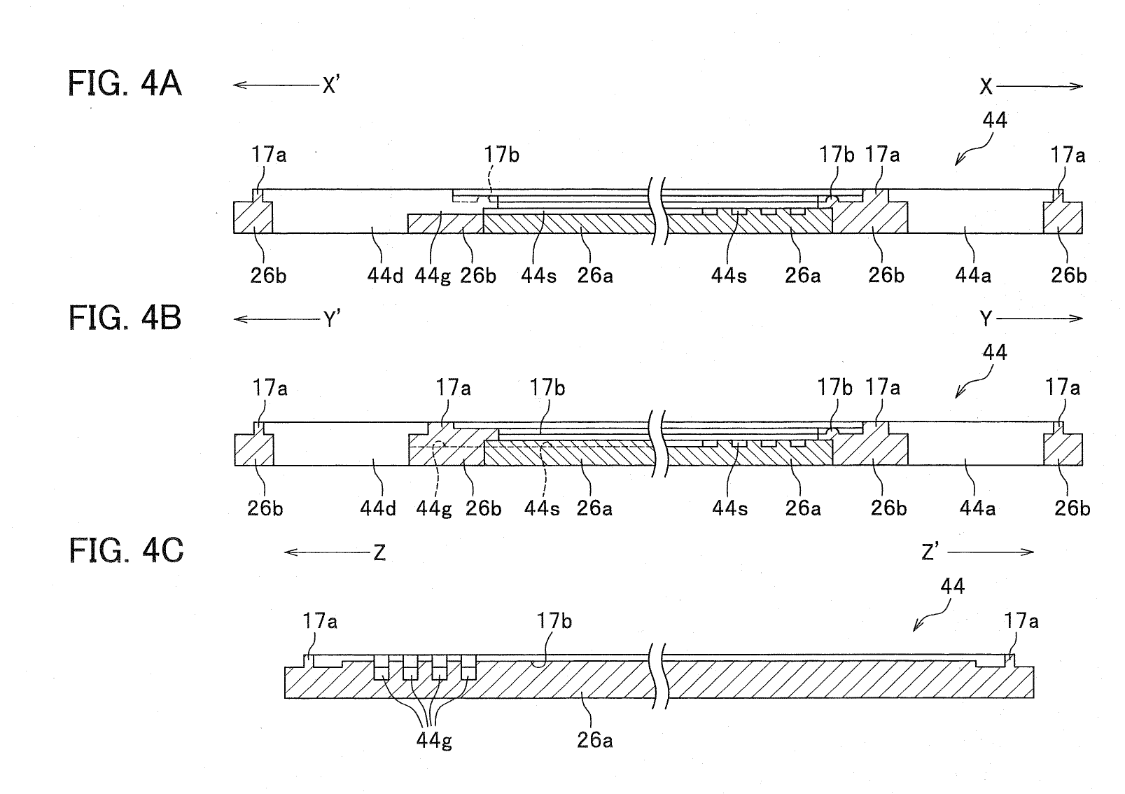

As shown in FIG. 2, the single cell 31 includes a membrane electrode assembly (MEA) 10 and a pair of conductive separators 44,45 sandwiching the membrane electrode assembly 10.

The membrane electrode assembly 10 includes a solid polymer electrolyte membrane 50 and an anode 42 formed on one side of the solid polymer electrolyte membrane 50, and a cathode 43 formed on the other side of the solid polymer electrolyte membrane 50. A periphery of the solid polymer electrolyte membrane 50 extends outside from peripheries of the anode 42 and the cathode 43. On a separator 44 side of the anode 42, a gas diffusion layer (not shown) is formed which has approximately the same surface configuration as that of the anode 42, and on a separator 45 side of the cathode 43, a gas diffusion layer (not shown) is formed which has approximately the same surface configuration as that of the cathode 43.

As shown in FIG. 2, the separator 44 is disposed on the anode 42 of the membrane electrode assembly 10.

The separator 44 includes: a metal part 26a made of metal in a shape of a plate corresponding to a face of the anode 42 and attached to a resin part 26b; and the resin part 26b in a shape of a frame framing the metal part 26a in a plane direction (i.e. the plane of the metal part 26a and the plane of the resin part 26b are on the same plane or approximately parallel to each other).

On a face of the metal part 26a opposed to the anode 42 (see FIG. 2), a flow passage 44s for hydrogen (reaction gas) is formed as engraved groove that connects a through-hole 44d and a through-hole 44c formed in the resin part 26b which will be described later.

As shown in FIG. 3, the flow passage 44s is formed of a set of four flow paths that meander on the face of the metal part 26a.

In the resin part 26b, through-holes 44a, 44b and 44c are formed at top, middle, bottom portions, respectively, of a left side of the resin part 26b in FIG. 2, and through-holes 44d, 44e and 44f are formed at top, middle, bottom portions, respectively, of a right side of the resin part 26b in FIG. 2. In addition, as shown in FIG. 3, the resin part 26b has a communicating passage 44g that connects the through-hole 44d and the flow passage 44s, and a communicating passage 44h that connects the flow passage 44s and the through-hole 44c.

As shown in FIG. 3, the communicating passage 44g penetrates across a sealing part 17a and a sealing part 17b, which will be described below, from a through-hole 44d side to communicate into the flow passage 44s formed in the metal part 26a. The communicating passage 44h penetrates across the sealing part 17a and the sealing part 17b from a through-hole 44c side to communicate into the flow passage 44s formed in the metal Dart 26a.

As shown in FIG. 3, the sealing part 17a and the sealing part 17b are disposed on the resin part 26b. In other words, the sealing part 17a and the sealing part 17b are disposed outside the metal part 26a.

As shown in FIGS. 3 and 4A-4C, the sealing part 17a is formed of a protrusion portion (ridge) protruding from a face on a flow passage 44s side of the separator 44. The sealing part 17a is configured to frame each of the through-holes 44a, 44b, 44c, 44d, 44e and 44f (see FIG. 3), and the sealing part 17b, which will be described below, that frames the metal part 26a (see FIG. 3). The sealing part 17a comes into contact with a sealing part 18a, which will be described below, formed in the separator 45 (see FIG. 5), to thereby seal the separator 44 and the separator 45 except the communicating passages 44g, 44h.

As shown in FIGS. 3 and 4A-4C, the sealing part 17b is formed of a protrusion portion (ridge) protruding from a face on the flow passage 44s side of the separator 44. The sealing part 17b is configured to frame the metal part 26a and be framed by the sealing part 17a (see FIG. 3). The sealing part 17b and a sealing part 18b formed on the separator 45 (see FIG. 5), which will be described later, sandwich a portion of the solid polymer electrolyte membrane 50 (see FIG. 2) extending at the peripheries of the membrane electrode assembly 10 (see FIG. 2), to thereby seal the separator 44 and the solid polymer electrolyte membrane 50 except the communicating passages 44g, 44h.

As shown in FIG. 2, the separator 45 is disposed on the cathode 43 of the membrane electrode assembly 10.

The separator 45 includes: a metal part 26a made of metal in a shape of a plate corresponding to a face of the cathode 43 and attached to a resin part 26b; and the resin part 26b in a shape of a frame framing the metal part 26a in a plane direction.

As shown in FIG. 5, on a face of the metal part 26a opposed to the cathode 43 (see FIG. 2), a flow passage 45s for air (reaction gas) is formed as engraved groove that connects a through-hole 45a and a through-hole 45f formed in the resin part 26b. The flow passage 45s is formed of a set of four flow paths that meander on the face of the metal part 26a.

As shown in FIG. 6, on an opposite side to a side with the flow passage 45s (see FIG. 5), the metal part 26a has a cooling-water channel 46s for running cooling water.

The cooling-water channel 46s is made of grooves separated by parallely arranged ribs 46c, the grooves extending from a through-holes 45a, 45b and 45c side to through-holes 45d, 45e and 45f side, which will be described below. The cooling water cools the fuel cell FC by running through the cooling-water channel 46s.

In the resin part 26b of the separator 45, through-holes 45a, 45b and 45c are formed at top, middle, bottom portions, respectively, of a left side of the resin part 26b in FIG. 2, and through-holes 45d, 45e and 45f are formed at top, middle, bottom portions, respectively, of a right side of the resin part 26b in FIG. 2. In addition, as shown in FIG. 5, the resin part 26b has a communicating passage 45g that connects the through-hole 45a and the flow passage 45s, and a communicating passage 45h that connects the flow passage 45s and the through-hole 45f.

As shown in FIG. 5, the communicating passage 45g penetrates across the sealing part 18a and the sealing part 18b, which will be described below, from a through-hole 45a side to communicate into the flow passage 45s formed in the metal part 26a. The communicating passage 45h penetrates across the sealing part 18a and the sealing part 18b, which will be described below, from a through-hole 45f side to communicate into the flow passage 45s formed in the metal part 26a.

As shown in FIG. 5, the sealing part 18a and the sealing part 18b are disposed on the resin part 26b of the separator 45. In other words, the sealing part 18a and the sealing part 18b are disposed outside the metal part 26a.

As shown in FIGS. 5 and 7A-7C, the sealing part 18a is formed of a protrusion portion (ridge) protruding from a face on a flow passage 45s side of the separator 45. The sealing part 18a is configured to frame each of the through-holes 45a, 45b, 45c, 45d, 45e and 45f (see FIG. 5), and the sealing part 18b, which will be described below, that frames the metal part 26a (see FIG. 5).

As shown in FIGS. 5 and 7A-7C, the sealing part 18b is formed of a protrusion portion (ridge) protruding from a face on the flow passage 45s side of the separator 45. The sealing part 18b is configured to frame the metal part 26a and be framed by the sealing part 18a (see FIG. 5). The sealing part 18b and the sealing part 17b (see FIG. 3) formed on the separator 44 (see FIG. 3) sandwich a portion of the solid polymer electrolyte membrane 50 (see FIG. 2) extending at the peripheries of the membrane electrode assembly 10 (see FIG. 2), to thereby seal the separator 45 and the solid polymer electrolyte membrane 50 except the communicating passages 45g, 45h.

On a cooling-water channel 46s side, the resin part 26b of the separator 45 has a communicating passage 46a that connects the through-hole 45b and the cooling-water channel 46s, and a communicating passage 46b that connects the cooling-water channel 46s and the through-hole 45e.

As shown in FIG. 6, the communicating passage 46a penetrates across a sealing part 19, which will be described below, from a through-hole 45b side to communicate into the cooling-water channel 46s formed in the metal part 26a. The communicating passage 46b penetrates across the sealing part 19 from a through-hole 45e side to communicate into the cooling-water channel 46s formed in the metal part 26a.

As shown in FIG. 6, the resin part 26b of the separator 45 has the sealing part 19 configured to frame each of the through-holes 45a, 45b, 45c, 45d, 45e and 45f, and the metal part 26a on the cooling-water channel 46s side. In other words, the sealing part 19 is disposed outside the metal part 26a. The sealing part 19 is formed of a protrusion portion (ridge) protruding from a face of the separator 45. The sealing part 19 comes into contact with an outer face of the separator 44 (see FIG. 3) of an adjacent single cell 31 (see FIG. 1), i.e. a face opposite to the face with the flow passage 44s of the adjacent single cell 31, to thereby seal the separator 45 and the separator 44 (see FIG. 3) of the adjacent single cell 31 (see FIG. 1), except the communicating passages 46a, 46b.

With respect to this fuel cell FC, when the stacked body 32 (see FIG. 1) is formed by stacking a plurality of single cells 31 shown in FIG. 2, the through-hole 44d and the through-hole 45d communicate with each other to form a supply hole (not shown) for supplying hydrogen to the flow passage 44s of the separator 44, and the through-hole 44c and the through-hole 45c communicate with each other to form an exhaust hole (not shown) for exhausting hydrogen from the flow passage 44s. The through-hole 44a and the through-hole 45a communicate with each other to form a supply hole (not shown) for supplying air (oxygen) to the flow passage 45s (see FIG. 3) of the separator 45, and the through-hole 44f and the through-hole 45f communicate with each other to form an exhaust hole (not shown) for exhausting air (oxygen) from the flow passage 45s. The through-hole 44b and the through-hole 45b communicate with each other to form a supply hole (not shown) for supplying cooling water to the cooling-water channel 46s of the separator 45, and the through-hole 44e and the through-hole 45e communicate with each other to form a drain hole (not shown) for draining cooling water from the cooling-water channel 46s. In other words, the through-holes 44a, 44b, 44c, 44d, 44e and 44f formed in the resin part 26b of the separator 44 and the through-hole 45a, 45b, 45c, 45d, 45e and 45f formed in the resin part 26b of the separator 45 correspond to either of “supply hole of reaction gas, exhaust hole of reaction gas, supply hole of cooling water, and drain hole of cooling water”.

Hereinafter, with respect to such a stacked body 32, portions of the through-hole 44d and the through-hole 45d will be mainly described in more detail, when the membrane electrode assembly 10 is sandwiched between the separator 44 and the separator 45.

As shown in FIGS. 8A and 8B, the separator 44 and the separator 45 that sandwich the membrane electrode assembly 10 therebetween are alternately stacked, and the sealing part 17a of the separator 44 comes into contact with the sealing part 18a of the separator 45 to thereby connect the through-hole 44d and the through-hole 45d and seal them, except the communicating passage 44g (see FIG. 8A). Likewise, when the sealing part 17a shown in FIG. 3 comes into contact with the sealing part 18a of the separator 45 shown in FIG. 5, the through-holes 44a, 44b, 44c, 44e and 44f of the separator 44 shown in FIG. 3 are separately sealed, except the communicating passage 44h shown in FIG. 3. At the same time, when the sealing part 18a shown in FIG. 5 comes into contact with the sealing part 17a of the separator 44 shown in FIG. 3, the through-holes 45a, 45b, 45c, 45e and 45f of the separator 45 shown in FIG. 5 are separately sealed, except the communicating passages 45h and 45g shown in FIG. 5. Finally, when the sealing part 17a of the separator 44 shown in FIG. 3 comes into contact with the sealing part 18a of the separator 45 shown in FIG. 5, the resin part 26b framing the metal part 26a of the separator 44 shown in FIG. 3 and the resin part 26b framing the metal part 26a of the separator 45 shown in FIG. 5 are sealed off.

As shown in FIGS. 8A-8C, a portion of the solid polymer electrolyte membrane 50 extending from the membrane electrode assembly 10 is sandwiched between the sealing part 17b of the separator 44 and the sealing part 18b of the separator 45. In other words, the sealing part 17b shown in FIG. 3 and the sealing part 18b shown in FIG. 5 sandwich the extending periphery of the solid polymer electrolyte membrane 50. As a result, the separator 44 and the extending periphery of the solid polymer electrolyte membrane 50 are sealed; at the same time, the separator 45 and the extending periphery of the solid polymer electrolyte membrane 50 are sealed off.

As shown in FIGS. 8A and 8B, between two adjacent single cells 31 in this stacked body 32, the separator 44 and the separator 45 face to each other. With the sealing part 19 of the separator 45 coming into contact with the resin part 26b of the separator 44, the through-hole 44d and the through-hole 45d are connected and sealed. Likewise, when the sealing part 19 comes into contact with the resin part 26b of the separator 44, the through-holes 45a, 45b, 45c, 45e and 45f of the separator 45 shown in FIG. 6 are separately sealed, except the communicating passages 46a, 46b shown in FIG. 5, and at the same time, the through-holes 44a, 44b, 44c, 44e and 44f (see FIG. 3) of the separator 44 corresponding to the through-holes 45a, 45b, 45c, 45e, 45f are separately sealed. The resin part 26b framing the metal part 26a of the separator 45 shown in FIG. 6 and the corresponding resin part 26b framing the metal part 26a of the separator 44 (see FIG. 3) are sealed off with the sealing part 19.

As shown in FIG. 1, in the fuel cell FC, a pair of end plates 33,34 sandwich and support the stacked body 32. It should be noted that, in the end plate 33, through-holes 33a, 33b, 33c, 33d, 33e and 33f are formed at positions corresponding to the through-holes 44a, 44b, 44c, 44d, 44e and 44f of the separator 44 (see FIG. 2) and the through-holes 45a, 45b, 45c, 45d, 45e and 45f of the separator 45 (see FIG. 2), respectively, and that the through-hole 33a serves as a supply hole of air (reaction gas), the through-hole 33f serves as an exhaust hole of air (reaction gas), the through-hole 33d serves as a supply hole of hydrogen (reaction gas), the through-hole 33c serves as an exhaust hole of hydrogen (reaction gas), the through-hole 33b serves as a supply hole of the cooling water, and the through-hole 33e serves as a drain hole of the cooling water.

Next, a resin compound used for forming the resin part 26b will be described.

Referring to the sealing part 17a of the separator 44 shown in FIG. 9A, the resin part 26b is formed of a single layer where particles 5 composed of rubber-like elastic body (hereinafter, frequently and simply referred to as “elastic particles 5”) are dispersed in a resin 4 making up a matrix phase, as shown in FIG. 9B, which is an enlarged view of a portion N. In the resin cart 26b, a content of the elastic particles 5 becomes higher in an inner portion than in a surface portion, desirably with a specific gradient (inclination) increasing from a surface side to an inner side. Such a content gradient (inclination) may be obtained by gradually increasing a distribution rate of elastic particles 5 having an approximately uniform diameter from the surface side of the resin part 26b to the inner side, or by gradually increasing a diameter of the elastic particles 5 from the surface side to the inner side. In a case of the resin part 26b of the present embodiment, as compared with a content of the elastic particles 5 in a surface portion 6 at a depth of approximately 50 μm from the surface, a content of the elastic particles 5 is made higher in an inner portion 7 which is between the surface portion 6 and a depth approximately 300 μm from the surface of the resin part 26b. Then, the entire surface of the resin part 26b is covered with the resin 4.

Any resin suffices for the resin 4 as long as the resin is moldable into a desired shape, but thermoplastic resins having no ester bond, amide bond or imide bond are preferred. Examples of preferable resins include polyolefin resin and styrene resin, such as polyethylene (PE), polypropylene (PP) and polybutylene; polyoxymethylene (POM), poly(vinyl chloride) (PVC), poly(phenylene sulfide) (PPS), poly(phenylene ether) (PPE), modified PPE, polysulfone (PSU), poly(ether sulfone) (PESE), polyketone (PK), poly(ether ketone) (PEK), poly(ether ether ketone) (PEEK), poly(ether nitrile) (PEN) and polyacrylonitrile (PAN). Ultrahigh-molecular-weight polyethylene, poly(phenylene sulfide), polysulfone, poly(ether nitrile) and polyacrylonitrile are especially preferred. Each single of these may be used or a combination of more than 2 selected from them may be used.

It is preferable that a content of the resin 4 be approximately 30-90 weight % of the resin compound used for forming the resin part 26b.

It is preferred that the rubber-like elastic body forming the elastic particles 5 be a material that elongates up to 200% or more without breaking, and does not change a volume thereof more than a range of from −10% to 10% after release of compression stress or expansion stress (tensile stress), as compared with the volume of the material before the stress release.

Examples of preferable rubber-like elastic body include synthetic rubbers, such as methyl methacrylate-butadiene rubber (MBR), ethylene-propylene rubber (EPR), acrylonitrile-butadiene rubber (NBR), styrene-butadiene rubber (SBR), chlorosulfonated polyethylene (CSP), chloroprene rubber (CR), isoprene rubber (IR), butyl rubber (IIR), acrylic rubber, fluororubber, silicone rubber, butadiene rubber (e.g., MBS: methyl methacrylate-butadiene-styrene), poly(phenylene sulfide) (PPS), ethylene-propylene-diene-methylene rubber (EPDM) ; styrene elastomers, such as styrene-butadiene-styrene (SBS) copolymer, styrene-isoprene-styrene (SIS) copolymer; olefin elastomer, urethane elastomer, polyamide elastomer, butadiene elastomer (MBS), vinyl chloride elastomer (TPVC). Each single of these may be used or a combination of more than 2 selected from them may be used.

The elastic particle 5 made of such a rubber-like elastic body may be formed of a single phase or multiple phases. For the elastic particle 5 formed of multiple phases, there can be mentioned a core-shell structure in which a core part is formed of an elastic polymer and a shell part is formed of a polymer having a functional group that enhances dispersability in the resin 4, for example.

It is preferable that the content of the elastic particles 5 (rubber-like elastic body) be approximately 10-70 weight % relative to the whole resin compound used for forming the resin part 26b.

In addition, the resin compound used for forming the resin part 26b may further include additional components if desired. Examples of additional components include fillers (such as mica, talc, kaolin, sericite, bentonite, Xonotlite, sepiolite, smectite, montmorillonite, wollastenite, silica, calcium carbonate, glass bead, glass flake, glass micro-balloon, clay, molybdenum disulfide, titanium oxide, zinc oxide, antimony oxide, calcium polyphosphate, graphite, barium sulfate, magnesium sulfate, zinc borate, calcium borate, aluminum borate whisker, potassium titanate whisker, zinc white and sulfur), pigment, dye, lubricant, mold-releasing agent, compatibilizing agent, dispersant, crystal nucleator, plasticizer, thermal stabilizer, antioxidant, color protection agent, UV absorber, fluidity reformer, foaming agent, antimicrobial agent, damping agent, antistatic agent and surfactant. Each single of these may be used or a combination of more than 2 selected from them may be used. The contents of these components may be appropriately selected within a range which does not hinder the purpose of the present invention.

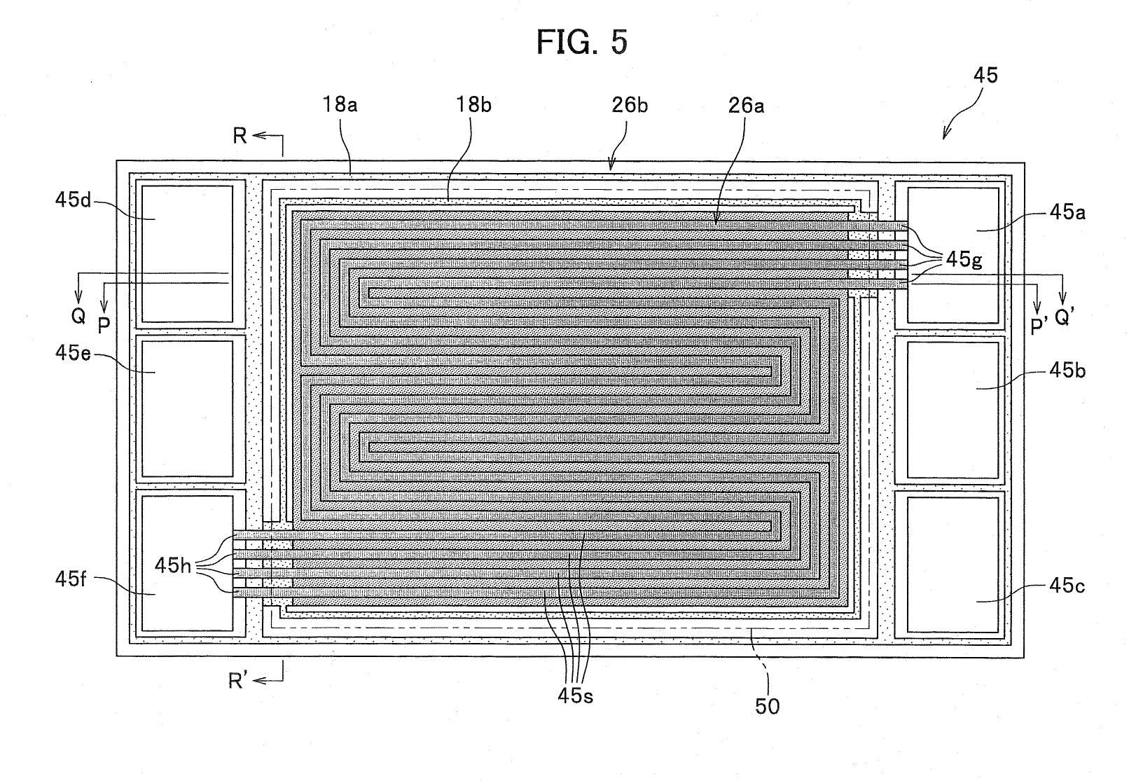

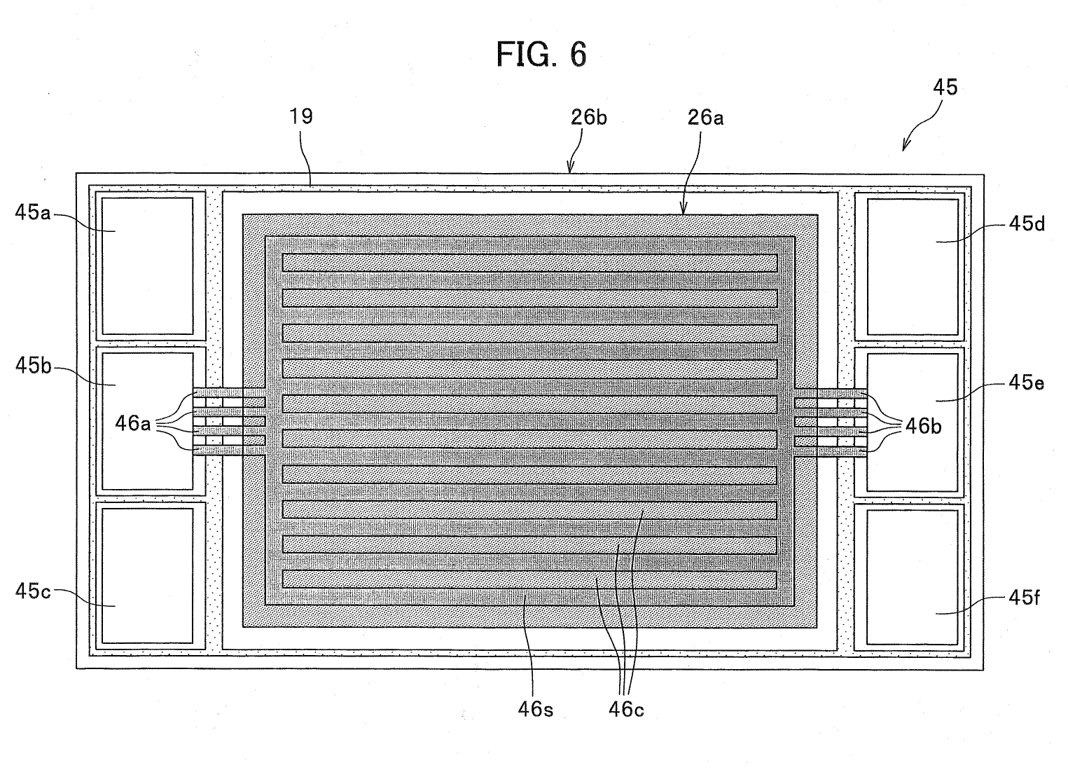

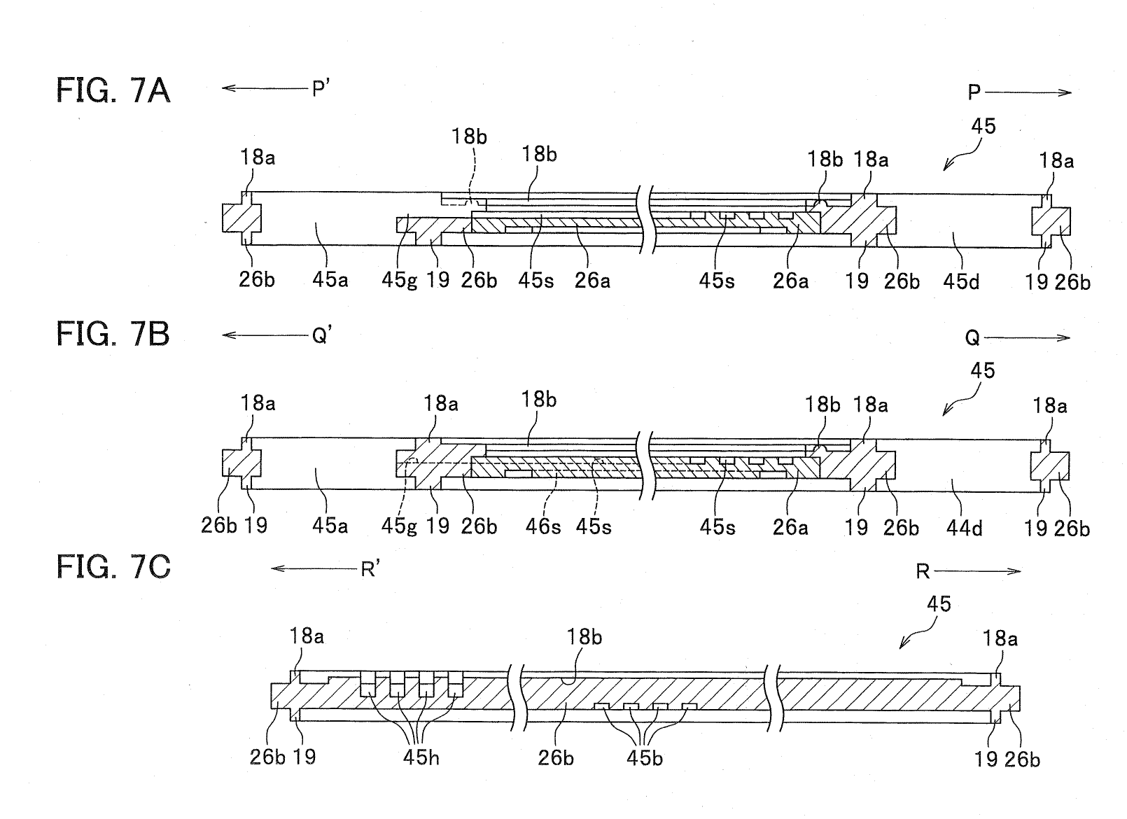

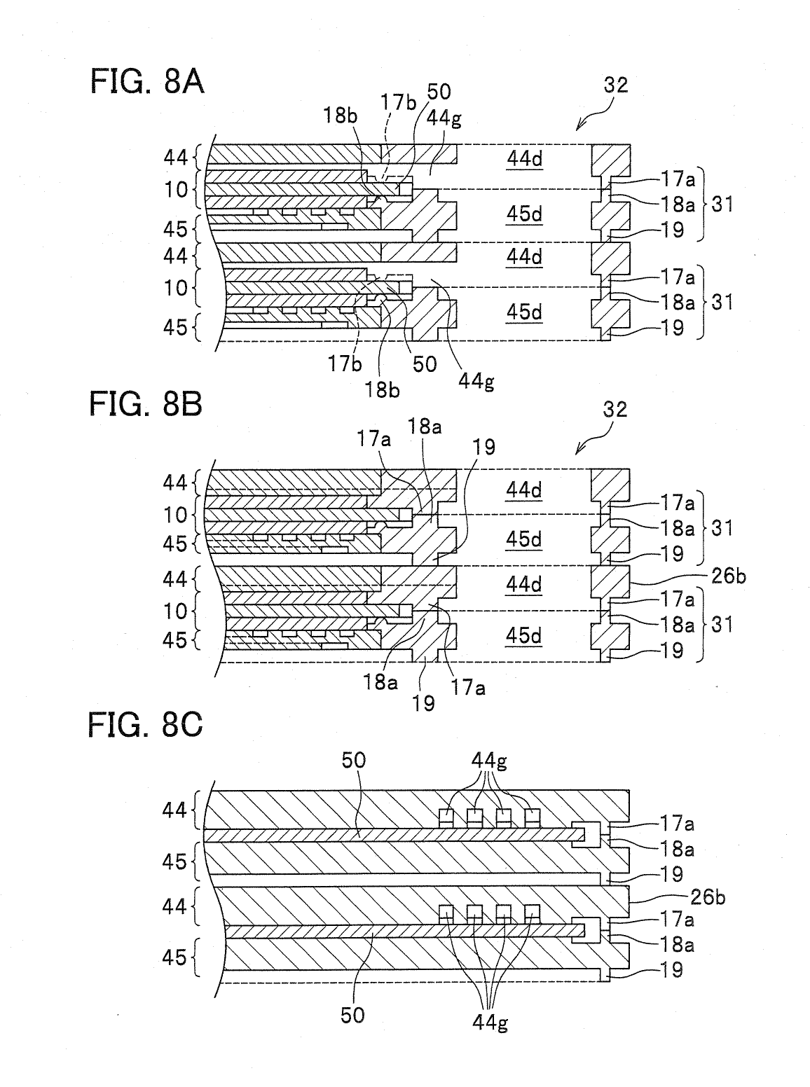

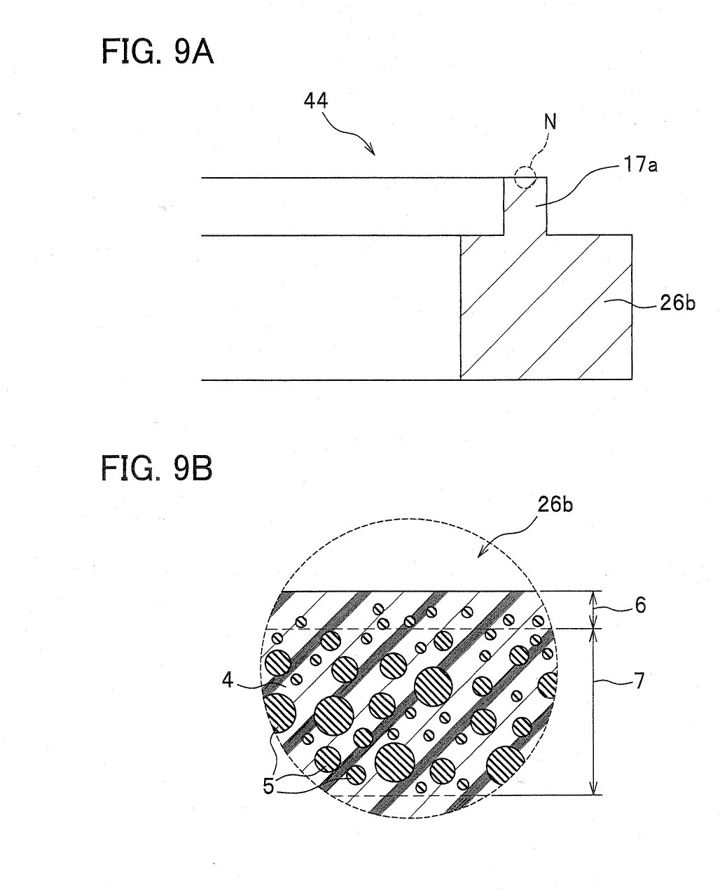

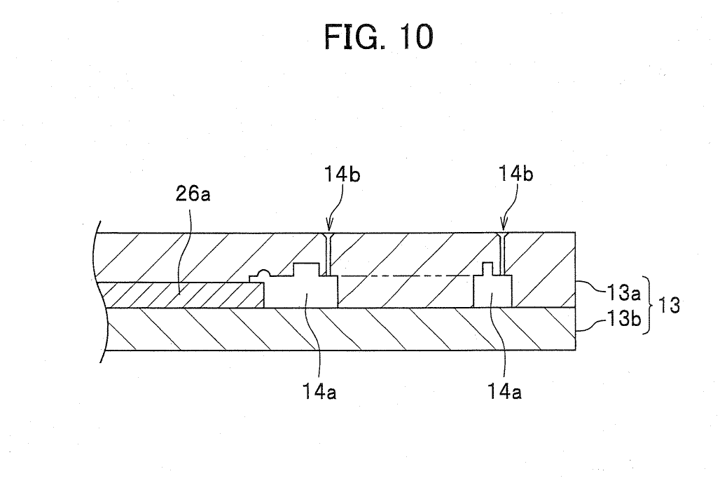

The separators 44, 45 each having the resin part 26b made of such a resin compound can be obtained by injection molding of the resin compound into a specific mold. FIG. 10 to be referred is a schematic diagram showing a partially sectional view of a mold used for production of the separator 44 (45).

As shown in FIG. 10, a mold 13 includes a lower mold 13b and an upper mold 13a. In the upper mold 13a, the metal part 26a is put in advance. The upper mold 13a is formed in such a manner that a cavity 14a has a shape corresponding to the profile of the resin part 26b of the separator 44 (45) and exposes portions of the metal part 26a. In the upper mold 13a, a gate 14b connecting to the cavity 14a is provided.

In the mold 13, the above-mentioned resin compound is introduced through the gate 14b. As a result, the separator 44 (45) in which the resin part 26b is attached to the metal part 26a is obtained.

Next, effects of the separators 44, 45 according to the present embodiment will be explained.

Since in the separators 44, 45 according to the present embodiment, the sealing parts 17a, 17b, 18a, 18b and 19 include the resin 4 making up a matrix phase and the particles 5 composed of the rubber-like elastic body dispersed in the resin 4, the sealing parts have acid resistance, and sealing property and structural strength are improved. At the same time, the separators 44, 45 can be easily made at a reduced cost.

Also in the separators 44, 45, the sealing parts 17a and 17b, as well as 18a, 18b and 19, are integrally formed, and thus a separator having a complex shape with a plurality of sealing parts 17a and 17b, or 18a, 18b and 19, can be easily formed.

In the separators 44, 45, the resin part 26b having the sealing parts 17a, 17b, 18a, 18b or 19 is formed to frame the metal part 26a, and therefore a separate sealing member for sealing the perimeter of the metal part 26a is not necessary, leading to reduction of parts to be used in the fuel cell FC.

In the separator 44, the through-holes 44a, 44b, 44c, 44d, 44e and 44f, and in the separator 45, the through-holes 45a, 45b, 45c, 45d, 45e and 45f (i.e., supply hole of reaction gas, exhaust hole of reaction gas, supply hole of cooling water and drain hole of cooling water) are formed in the resin part 26b. Therefore, short circuit at the through-hole(s) of the cingle cells 31 adjacent to each other are prevented, which may otherwise be caused by water or the like present in the through-hole(s).

In the separators 44, 45, the resin part 26b and the metal part 26a are unified, leading to reduction of parts. In addition, when a fuel cell FC is produced by stacking single cells 31, they can be steadily and easily stacked.

### (Sealing Member for Fuel Cell)

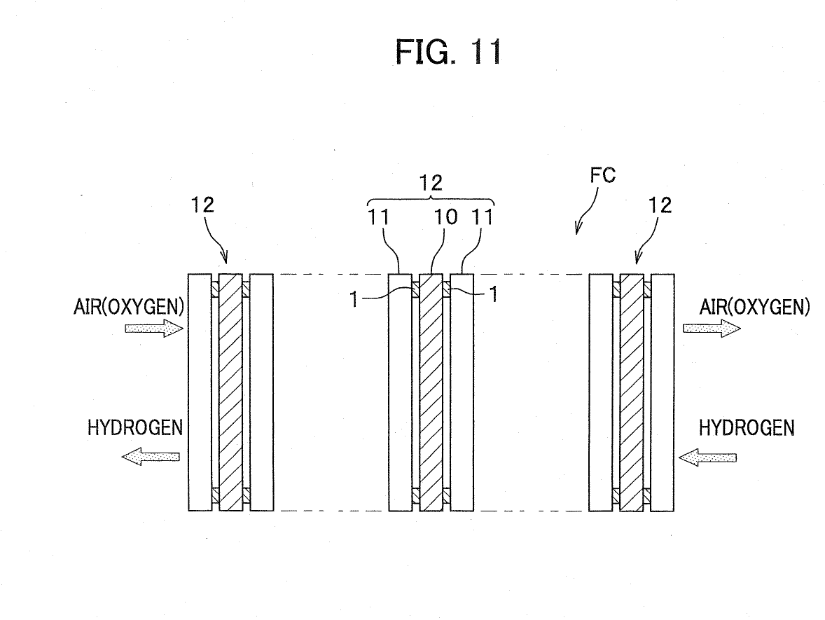

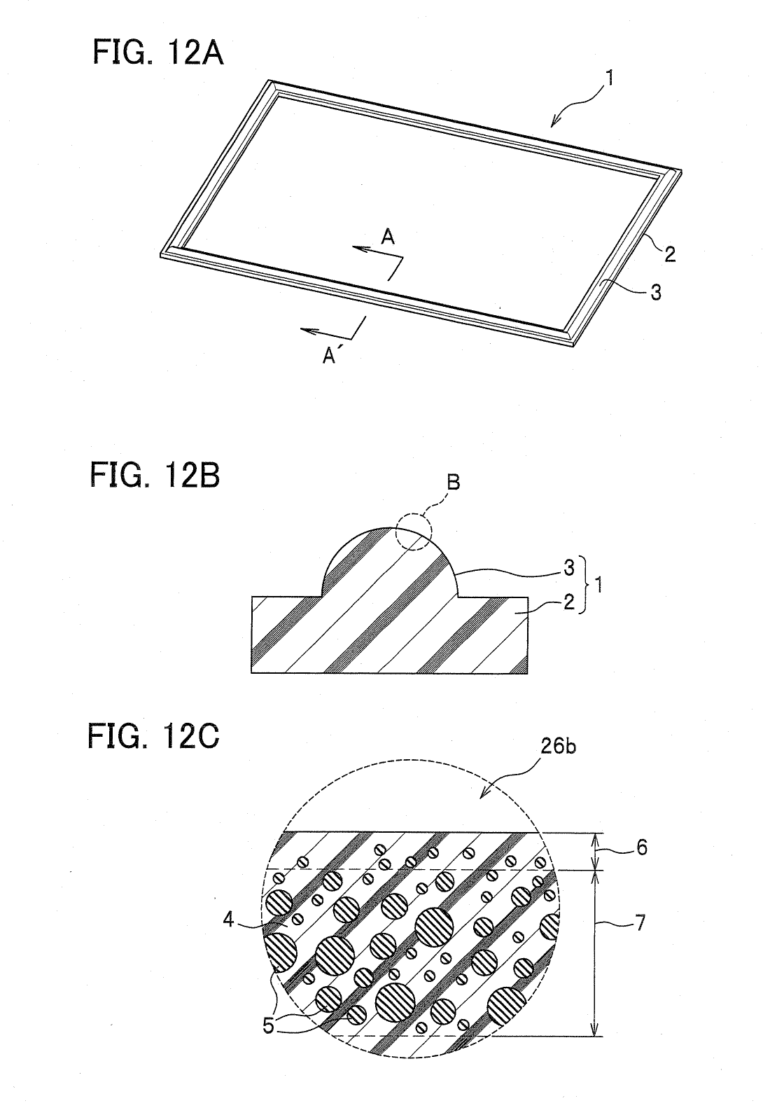

Next, embodiments of the sealing member for a fuel cell according to the present invention will be described with reference to the drawings. In the drawings to be referred, FIG. 11 is a schematic diagram showing a fuel cell using a sealing member for a fuel cell according to one embodiment. FIG. 12A is a perspective view of a sealing member for a fuel cell according to one embodiment; FIG. 12B is a sectional view taken along the line A-A′ of FIG. 12A; and FIG. 12C is an enlarged view of a portion B in FIG. 12B.

First, prior to the description of the sealing member for a fuel cell (hereinafter, simply referred to as “sealing member”) a fuel cell using the sealing member will be briefly explained.

As shown in FIG. 11, a fuel cell FC is formed of a plurality of single cells 12 stacked on one another, with each single cell 12 being formed of a membrane electrode assembly (MEA) 10 and conductive separators 11,11 sandwiching the MEA 10. It should be noted that, the membrane electrode assembly 10 includes a solid polymer electrolyte membrane (not shown), a cathode (not shown) provided on one side of the solid polymer electrolyte membrane, and an anode (not shown) on the other side, as is well known. When the anode and the cathode are supplied with hydrogen and air (oxygen), respectively, the fuel cell FC generates electric power.

Next, the sealing member according to the present embodiment will be described.

As shown in FIG. 11, the sealing member 1 according to the present embodiment is disposed between the membrane electrode assembly 10 and the separator 11. As shown in FIG. 12A, the sealing member 1 is in a shape of a rectangular frame. As is apparent from FIG. 11, the sealing member 1 is disposed along peripheries of the membrane electrode assembly 10 and the separator 11. As shown in FIG. 12B, the sealing member 1 is formed of a base portion 2 and a protruding portion 3 protruding from the base portion 2, and when seen as a cross section, the sealing member 1 has a combined shape of a rectangular and a semi-circle for the respective portions. It should be noted that, in the sealing member 1 of the present embodiment, the base portion 2 and the protruding portion 3 come in close contact with the membrane electrode assembly 10 and the separator 11 (see FIG. 11), respectively.

The sealing member 1 is formed of a single layer where particles 5 composed of rubber-like elastic body (hereinafter, frequently and simply referred to as “elastic particles 5”) are dispersed in a resin 4 making up a matrix phase, as shown in FIG. 12C. In the sealing member 1, a content of the elastic particles 5 becomes higher in an inner portion than in a surface portion, desirably with a specific gradient (inclination) increasing from a surface side to an inner side. Such a content gradient (inclination) may be obtained by gradually increasing a distribution rate of elastic particles 5 having an approximately uniform diameter from the surface side of the sealing member 1 to the inner side, or by gradually increasing a diameter of the elastic particles 5 from the surface side to the inner side. In a case of the sealing member 1 of the present embodiment, as compared with a content of the elastic particles 5 in a surface portion 6 at a depth of approximately 50 μm from the surface, a content of the elastic particles 5 is made higher in an inner portion 7 which is between the surface portion 6 and a depth approximately 300 μm from the surface of the sealing member 1. Then, the entire surface of the sealing member 1 is covered with the resin 4.

Any resin suffices for the resin 4 as long as the resin is moldable into a desired shape, but thermoplastic resins having no ester bond, amide bond or imide bond are preferred. Examples of preferable resins include polyolefin resin and styrene resin, such as polyethylene (PE), polypropylene (PP) and polybutylene; polyoxymethylene (POM), polyvinyl chloride) (PVC), poly(phenylene sulfide) (PPS), poly(phenylene ether) (PPE), modified PPE, polysulfone (PSU), poly(ether sulfone) (PESF), polyketone (PK), poly(ether ketone) (PEK), poly(ether ether ketone) (PEEK), poly(ether nitrile) (PEN) and polyacrylonitrile (PAN). Ultrahigh-molecular-weight polyethylene, poly(phenylene sulfide), polysulfone, poly(ether nitrile) and polyacrylonitrile are especially preferred. Each single of these may be used or a combination of more than 2 selected from them may be used.

It is preferable that a content of the resin 4 be approximately 30-90 weight % of the sealing member 1.

It is preferred that the rubber-like elastic body forming the elastic particles 5 be a material that elongates up to 200% or more without breaking, and does not change a volume thereof more than a range of from −10% to 10% after release of compression stress or expansion stress (tensile stress), as compared with the volume of the material before the stress release.

Examples of preferable rubber-like elastic body include synthetic rubbers, such as methyl methacrylate-butadiene rubber (MBR), ethylene-propylene rubber (EPR), acrylonitrile-butadiene rubber (NBR), styrene-butadiene rubber (SBR), chlorosulfonated polyethylene (CSP), chloroprene rubber (CR), isoprene rubber (IR), butyl rubber (IIR), acrylic rubber, fluororubber, silicone rubber, butadiene rubber (e.g., MBS: methyl methacrylate-butadiene-styrene), poly(phenylene sulfide) (PPS), ethylene-propylene-diene-methylene rubber (EPDM); styrene elastomers, such as styrene-butadiene-styrene (SBS) copolymer, styrene-isoprene-styrene (SIS) copolymer; olefin elastomer, urethane elastomer, polyamide elastomer, butadiene elastomer (MBS), vinyl chloride elastomer (TPVC). Each single of these may be used or a combination of more than 2 selected from them may be used.

The elastic particle 5 made of such a rubber-like elastic body may be formed of a single phase or multiple phases. For the elastic particle 5 formed of multiple phases, there can be mentioned a core-shell structure in which a core part is formed of an elastic polymer and a shell part is formed of a polymer having a functional group that enhances dispersability in the resin 4, for example.

It is preferable that the content of the elastic particles 5 (rubber-like elastic body) be approximately 10-70 weight % relative to the whole sealing member 1.

In addition, the sealing member 1 may further include additional components if desired. Examples of additional components include fillers (such as mica, talc, kaolin, sericite, bentonite, Xonotlite, sepiolite, smectite, montmorillonite, wollastenite, silica, calcium carbonate, glass bead, glass flake, glass micro-balloon, clay, molybdenum disulfide, titanium oxide, zinc oxide, antimony oxide, calcium polyphosphate, graphite, barium sulfate, magnesium sulfate, zinc borate, calcium borate, aluminum borate whisker, potassium titanate whisker, zinc white and sulfur), pigment, dye, lubricant, mold-releasing agent, compatibilizing agent, dispersant, crystal nucleator, plasticizer, thermal stabilizer, antioxidant, color protection agent, UV absorber, fluidity reformer, foaming agent, antimicrobial agent, damping agent, antistatic agent and surfactant. Each single of these may be used or a combination of more than 2 selected from them may be used. The contents of these components may be appropriately selected within a range which does not hinder the purpose of the present invention.

### (Method for Producing Sealing Member)

Next, a method for producing the sealing member 1 will be described.

The production method includes a first step of heat-mixing of the resin 4 and the elastic particles 5 to obtain a resin compound, and a second step of injection molding of the resin compound into a mold.

In the first step, the resin 4 and the elastic particles 5 are heated and mixed. The first step may be a step in which the resin 4 is molten by heating and the elastic particles 5 is added thereto and mixed, or a step in which a mixture of the resin 4 and the elastic particles 5 is heated, and at least the resin 4 is molten. A mixing ratio of the resin 4 and the elastic particles 5 can be determined based on the contents of the resin 4 and elastic particles 5 in the sealing member 1 as mentioned above. To the resin compound obtained in the first step, various additional components can be added as described above.

A heating temperature in the first step is appropriately determined above the melting point of the resin 4 to be used, and preferably is below the glass transition temperature of the rubber-like elastic body forming the elastic particles 5. The first step can be performed with a conventional heat-kneading machine, such as a biaxial kneader. In the production method of the present embodiment, the resin compound is pelletized and subjected to the second step which will be described below.

Examples of the injection molding performed in the step 2 include injection compression molding, gas-assist injection molding and insert molding. An injection molding machine to be used may be one with a conventional structure, for example, one having: a hopper as an inlet for a pelletized resin compound; a kneading mechanism for preparing a plasticized resin compound by heating and kneading the resin compound; and a nozzle for discharging the plasticized resin compound into a cavity of a mold. The kneading mechanism has, as is well known, a cylinder, a screw disposed in the cylinder, a motor for rotating the screw, and a heater for heating an inside of the cylinder.

Any mold suffices for the mold to be used in the present invention as long as there is a cavity having a shape corresponding to the sealing member 1 formed therein, and those made of the known materials, such as metal and resin can be mentioned.

In the second step, by discharging the resin compound from the injection molding machine into the mold, the sealing member 1 is obtained. It should be noted that, in the insert molding, the sealing member 1 can be produced so that the separator 11 and the sealing member 1 are unified, or the membrane electrode assembly 10 and the sealing member 1 are unified.

Next, the sealing member 1 according to the present embodiment and effects of the production method will be described.

Since the elastic particles 5 are dispersed in the resin 4 as a matrix phase, the sealing member 1 exhibits acid resistance due to the resin 4, as well as elasticity due to the elastic particles 5, which gives excellent sealing property to the sealing member 1. Since acid resistance is steadily provided by the resin 4, unlike the conventional sealing member, the sealing member 1 does not require expensive fluororubber and can be produced at a reduced cost.

In addition, the sealing member 1 can be easily produced by molding the resin 4 (resin compound) in which the elastic particles 5 are dispersed.

Further, by adjusting the content of the elastic particles 5 in the sealing member 1, elasticity of the sealing member 1 can be controlled. Therefore, in the fuel cell FC having a stacking structure with a fixed length, the sealing member 1 can serve as a spring member having a spring constant determined by design, and thus a disc spring holding the stacking structure becomes unnecessary, leading to reduction of a volume and a weight of the fuel cell FC.

In addition, since the sealing member 1 is formed of a single layer, there is no concern about interlayer separation, unlike the case of the conventional sealing member formed of two layers (see, for example, the patent document previously described).

Further, in the sealing member 1, as compared with the amount of the elastic particles 5 in the surface portion 6, the amount of the elastic particles 5 in the inner portion 7 is made larger, leading to a higher content of the resin 4 at the surface portion 6. Therefore, acid resistance of the sealing member 1 is further enhanced.

In addition, in the sealing member la having a content of the elastic particles 5 of from 10 weight % to 70 weight %, elasticity is obtained while elution of the rubber-like elastic body is suppressed. Therefore, the sealing member 1 is prevented from being deteriorated.

Further, since the entire surface of the sealing member 1 is covered with the resin 4 (matrix phase), elution of the rubber-like elastic body is steadily suppressed. As a result, the sealing member 1 is effectively prevented from being deteriorated.

In the method for producing the sealing member 1, by discharging the resin compound containing the resin 4 and the elastic particles 5 from the injection molding machine into the specific mold, the sealing member 1 formed of a single layer can be obtained.

In addition, in the production method, when the resin compound is discharged into the mold, the resin component in the resin compound becomes higher in a vicinity of an interface between the mold and the resin compound, due to an affinity (wettability) between the resin 4 and the mold. Therefore, the sealing member 1 can be obtained in which the content of the elastic particles 5 becomes gradually higher as a distance from the mold increases, i.e., from a surface portion side to an inner portion side. Then, the sealing member 1 with the entire surface thereof covered with the resin 4 can be molded.

Further, according to the present production method, unlike the conventional method for producing sealing member (see, for example, the patent document previously described), there is no need to perform two-layer extrusion. Moreover, the injection molding facilitates continual production of the sealing member. In this case, by injection molding in which a mold is compressed after injection, the sealing member can be made to have more complex shape, and still further, by performing insert molding in which a separator is put in a mold, a fuel cell member can be accurately produced at a reduced cost. Therefore, as compared with the conventional method for producing sealing member, the sealing member 1 can be easily produced at a reduced cost.

In addition, in this production method, compatible dissolution of the resin 4 and the elastic particles 5 can be prevented, by making the heating temperature in the first step at a lower temperature than the glass transition temperature of the rubber-like elastic body forming the elastic particles 5. As a result, according to the present production method, the sealing member 1 exhibiting more excellent elasticity can be obtained.

The present invention is not limited to the above embodiments, and it is a matter of course that the above embodiment may be properly modified.

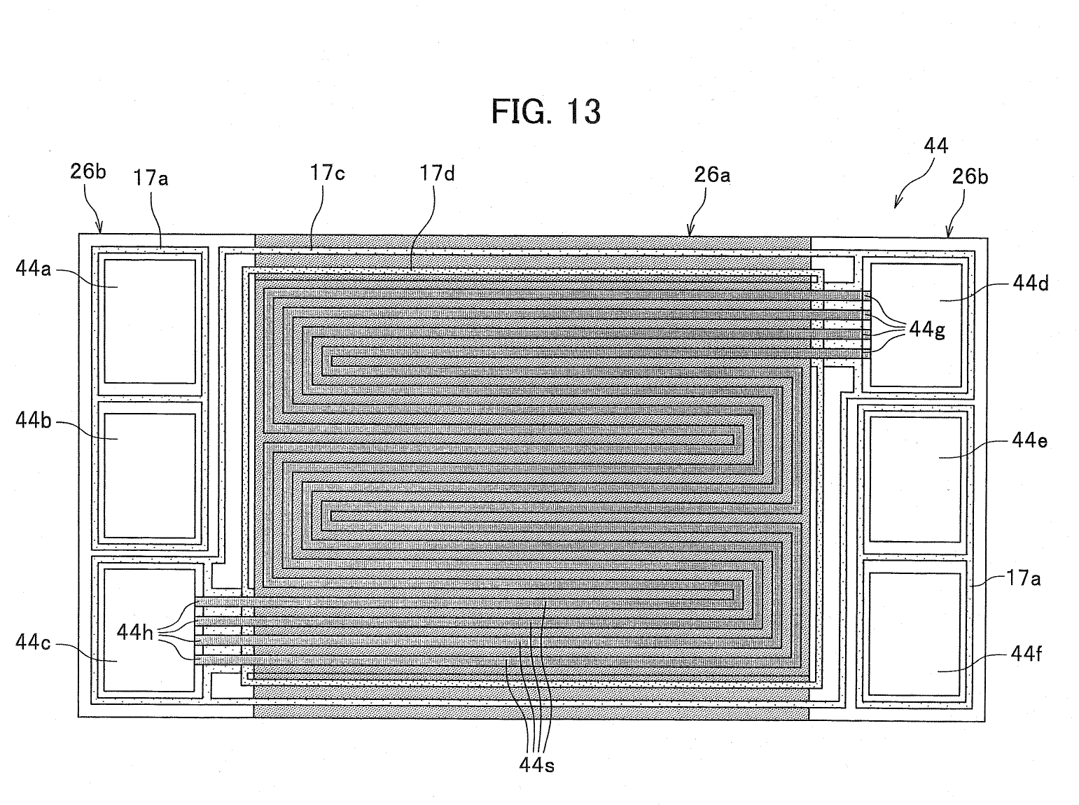

In the above-mentioned embodiment, the separators 44, 45 are formed so that the resin part 26b frames the metal part 26a, but the present invention is not limited to this embodiment. FIG. 13 to be referred shows a separator according to another embodiment, and is a plan view of a separator disposed on an anode side, seen from the membrane electrode assembly side. In this embodiment, the same components as in the above-mentioned embodiment are designated with the same reference characters, and thus a duplicate description is omitted.

As shown in FIG. 13, in this separator 44, resin parts 26b, 26b are formed on both sides of a metal part 26a.

In such a separator 44, a sealing part 17a integrally formed with the resin part 26b is disposed at perimeters of through-holes 44a, 44b, 44e and 44f. A sealing part 17c and a sealing part 17d are disposed in such a manner that they extend on both a face of the metal part 26a and a face of the resin part 26b, and formed separately from the separator 44. The sealing part 17c frames through-holes 44c, 44d, the sealing part !7d, and a flow passage 44s formed in the metal part 26a. Inside the sealing part 17c, the sealing part 17d frames the flow passage 44s, and like in the case of the sealing part 17b of the separator 44 according to the above-mentioned embodiment, seals the solid polymer electrolyte membrane 50 (see FIG. 2) at a periphery of the membrane electrode assembly 10 and the separator 44. It is desirable that the sealing parts 17c, 17d be made of the above-mentioned resin compound.

In the embodiment above, the sealing member 1 is disposed between the separator 11 and the membrane electrode assembly 10. However, the sealing member 1 used for the fuel cell FC in which each single cell 12 has a pair of the separators 11 may be disposed between two separators 11.

In the above-mentioned embodiment, the sealing member 1 having the base portion 2 and the protrusion portion 3 provided on one side of the base portion 2 was illustrated. However, the present invention is not limited to the embodiment, and the sealing member may be formed exclusively of the base portion 2, or may be formed of the base portion 2 with the protruding portions 3 provided on opposite two sides of the base portion 2.

### EXAMPLES

Next, the present invention will be described with referring to Examples.

### Examples 1-8

For each Examples, first, a resin compound including a resin, elastic particles formed of rubber-like elastic body and additional components in specific amounts shown in Table 1 (unit of numerals: part by weight) was prepared.

TABLE 1

| | | Ex 1 | Ex 2 | Ex 3 | Ex 4 | Ex 5 | Ex 6 | Ex 7 | Ex 8 |
|---|---|---|---|---|---|---|---|---|---|
| Resin | | PVC | PPS | PPS | Ultra-high | PVC | PVC | PPS | PPS |
| (part by weight) | | (45) | (40) | (35) | molecular | (60) | (45) | (45) | (25) |
| | | | | | PE (85) | | | | |
| Rubber-like | | MBS | MBS | SBS | MBS | TPVC | EPDM | SBS | SBS |
| elastic body | | (35) | (45) | (65) | (9) | (30) | (35) | (30) | (75) |
| (part by weight) | | NBR | NBR | | NBR | | | CR | |
| | | (10) | (5) | | (5) | | | (20) | |
| Additional | Glass | 8 | 10 | 1 | 5 | 10 | 8 | 3 | 1 |
| component | bead | | | | | | | | |
| (part by | Anti- | 0.2 | 0.2 | 0.2 | 0.2 | 0.2 | 0.2 | 0.2 | 0.2 |
| weight) | oxidant | | | | | | | | |
| | Titanium | 1 | | | 1 | 1 | | | |
| | oxide | | | | | | | | |
| | Zinc | | | | | | 2 | | |
| | white | | | | | | | | |
| | Sulfur | | | | | | 0.8 | | |
| | Vulcanizing | | | | | | 0.2 | | |
| | agent | | | | | | | | |
| | Stearic | | | | | | 0.2 | | |
| | acid | | | | | | | | |
| | Stabilizer | 0.5 | | | | | | | |

| | | | | | | | | |
|---|---|---|---|---|---|---|---|---|
| Mold temperature | 100 | 130 | 130 | 83 | 100 | 100 | 130 | 130 |
| upon molding (° C.) | | | | | | | | |
| Sealing capability | good | good | good | good | good | good | good | good |
| at 80° C. | | | | | | | | |
| Sealing capability | good | good | good | good | good | good | good | good |
| at −20° C. | | | | | | | | |
| Sealing capability | good | good | good | good | good | good | good | good |
| after iterative | | | | | | | | |
| high-load | | | | | | | | |
| Acid resistance | good | good | good | good | good | good | good | moderate |

In the “resin” row of Table 1, PVC represents poly(vinyl chloride) (HA-27F manufactured by Sekisui Chemical Co., Ltd.); PPS represents poly(phenylene sulfide) (A-900 manufactured by Toray Industries, Inc.); and ultrahigh molecular PE represents ultrahigh molecular polyethylene (Sunfine™ UH-950 manufactured by Asahi Kasei Chemicals Corporation). In the “rubber-like elastic body” row, MBS represents butadiene elastomer (Metablen C-223A manufactured by Mitsubishi Rayon Co., Ltd.); NBR represents acrylonitrile-butadiene rubber (N-260S manufactured by JSR Corporation); SBS represents styrene-butadiene-styrene copolymer (Tuftec™ H1052 manufactured by Asahi Chemicals Corporation); TPVC represents vinyl chloride elastomer (Denka Rheomer G manufactured by Denki Kagaku Kogyo Kabushiki Kaisha); EPDM represents ethylene-propylene-dimethyl rubber (46160 manufactured by The Dow Chemical Company); and CR represents chloroprene rubber (Denka chloroprene manufactured by Denki Kagaku Kogyo Kabushiki Kaisha) In the “additional component” row, glass bead is EMB-10 manufactured by Potters-Ballotini Co., Ltd., antioxidant is IRGANOX™ 1010 manufactured by Ciba Specialty Chemicals, titanium oxide, sulfur, stabilizer (tributyl tin oxide) and stearic acid are those manufactured by Wako Pure Chemical Industries, Ltd., and vulcanizing agent is Vulnoc DGM manufactured by Ouchi Shinko Chemical Industrial Co., Ltd.

The resin compound was prepared by heat-mixing of the components shown in Table 1. In this preparation, a biaxial extruder (TEM-48SS manufactured by Toshiba Machine Co., Ltd.) was used and the resin compound was pelletized.

Next, injection compression molding was performed using the pelletized resin compound to obtain a sealing member. For an injection molding machine, a type 350 injection molding machine manufactured by Mitsubishi Heavy Industries, Ltd was used in this step, a stainless plate (of SUS316) in a rectangular shape when seen as a plane view was disposed in the mold, and a sealing member in a shape of a frame was formed in such a manner that the sealing member is disposed along a periphery of the stainless plate. The sealing member was unified with the stainless plate. Temperature of the mold upon molding (mold temperature) is shown in Table 1.

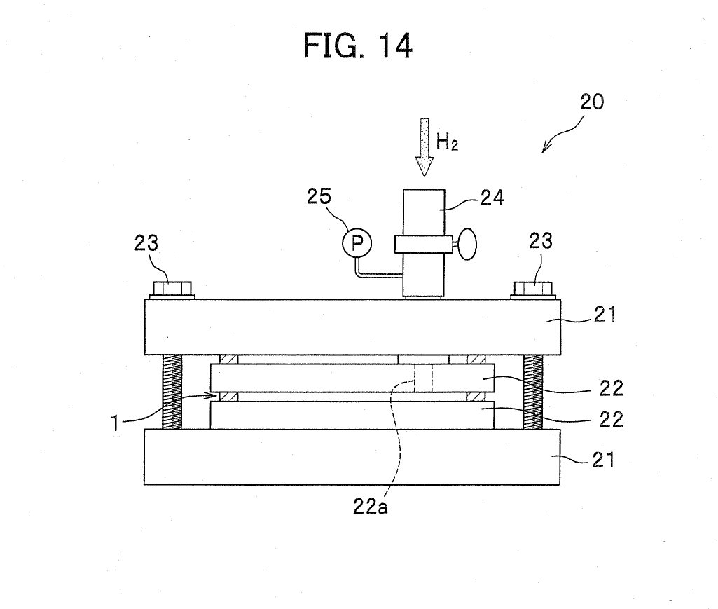

Next, a test for evaluating sealing capability was carried out with respect to the obtained sealing member. FIG. 14 is a schematic diagram of a test device used for seal performance evaluation test. As shown in FIG. 14, a test device 20 includes: a pair of pressing plates 21; bolts 23 for fastening the pressing plates 21; a hydrogen gas supply pipe 24 for sending hydrogen gas (H₂) of a predetermined pressure between stainless plates 22 which will be described below; and a pressure gauge 25 measuring a pressure between the stainless plates 22.

In the evaluation test for sealing capability, first, as shown in FIG. 14, the sealing member 1 unified with the stainless plate 22 is sandwiched between the stainless plates 22 having the same shape, and disposed between the pressing plates 21 of the test device 20. A sealing linear pressure of the sealing member 1 was made 5 kg/cm by fastening the bolts 23. Next, through a hole 22a formed in the stainless plate 22, hydrogen gas was supplied between the stainless plates 22 from the hydrogen gas supply pipe 24. The pressure of hydrogen gas between the stainless plates 22 was made 200 kPa.

The test device was left for 10 minutes, and pressure drop of hydrogen gas between the stainless plates 22 was measured. When the pressure drop is within 5%, the sealing member 1 is judged as capable of sealing. In Tables, the sealing member 1 with sealing capability is indicated with “good” and the sealing member with no sealing capability is indicated with “no good”. It should be noted that the evaluation tests were performed for temperatures of the sealing member 1 of 80° C. and −20° C.

The bolts 23 were fastened so that the sealing linear pressure became 7 kg/cm and then loosened. This procedure was repeated 30 times, and evaluation test for sealing capability at 80° C. was performed in substantially the same manner as described above. The results are shown in a “sealing capability after iterative high-load” row in Table 1.

Next, with respect to the obtained sealing member, acid resistance test was performed. In the acid resistance test, 10 g of the obtained sealing member was immersed in 100 ml of an acid solution (pH 2, 80° C.) for 100 hours, and the acid solution was concentrated until the volume became 20 ml (5-fold concentration) to thereby obtain a specimen. An eluted component in the specimen was analyzed with an ICP (Inductively Coupled Plasma) luminescent analyzer.

In Tables, a sealing member with the eluted component of lower than 100 ppm is judged as having excellent acid resistance and indicated with “good”. A sealing member with the eluted component of 100 ppm or more and less than 200 ppm is judged as having moderate acid resistance and indicated with “moderate”. A sealing member with the eluted component of 200 ppm or more is judged as having no acid resistance and indicated with “no good”.

### Comparative Example 1

A resin compound including a resin and additional components in specific amounts shown in Table 2 (unit of numerals: part by weight) was prepared. A sealing member was obtained in substantially the same manner as in Examples except that the resin compound in Table 2 was used. With respect to the sealing member, evaluation test for sealing capability and acid resistance was performed in substantially the same manner as described above. The results are shown in Table 2.

TABLE 2

| | | Compara- | Compara- | Compara- |
|---|---|---|---|---|
| | | tive | tive | tive |
| | | Example 1 | Example 2 | Example 3 |
| Resin (part by weight) | | Ultrahigh | | |
| | | molecular | | |
| | | PE (98) | | |
| Rubber-like elastic body | | | EPDM | silicone |
| (part by weight) | | | sealing | rubber |
| | | | member | sealing |
| | | | | member |
| Additional | Glass bead | | 1 | |
| component | Antioxidant | | 0.2 | |
| (part by | Titanium | | 1 | |
| weight) | oxide | | | |

| | | | |
|---|---|---|---|
| Mold temperature upon | 83 | | |
| molding (° C.) | | | |
| Sealing capability at 80° C. | good | good | good |
| Sealing capability at −20° C. | no good | good | good |
| Sealing capability after | no good | good | good |
| iterative high-load | | | |
| Acid resistance | good | no good | no good |

### Comparative Examples 2 and 3

For the test for evaluating sealing capability and acid resistance, substantially the same procedures were repeated as described above, with respect to the sealing member made of ethylene-propylene-dimethyl rubber (EPDM sealing member) in Comparative Example 2, and to the sealing member made of silicone rubber (silicone rubber sealing member) in Comparative Example 3.

### Result of Evaluation Test

The sealing members obtained in Examples 1-8 have sealing capability as shown in Table A. All of the sealing members obtained in Examples 1-8 exhibit good acid resistances, and especially, those obtained in Examples 1-7 are excellent in acid resistance, with a content of rubber-like elastic body being 10-mass %.

On the other hand, through exhibiting acid resistance, the sealing member obtained in Comparative Example 1 does not exhibit sealing capability at −20° C. and sealing capability after iterative high-load, since the sealing member does not contain elastic particles.

Though exhibiting sealing capability, the sealing members obtained in Comparative examples 2 and 3 do not exhibit acid resistance, since the sealing members do not contain resin.

### Examples 9 and 10

First, a resin compound including a resin, elastic particles formed of rubber-like elastic body and additional components in specific amounts shown in Table 3 (unit of numerals: part by weight) was prepared.

TABLE 3

| | | Example 9 | Example 10 |
|---|---|---|---|
| Resin (part by weight) | | PVC (45) | PPS (40) |
| Rubber-like elastic body | | MBS (35) | MBS (45) |
| (part by weight) | | NBR (10) | NBR (5) |
| Additional | Glass bead | 8 | 10 |
| component | Antioxidant | 0.2 | 0.2 |
| (part by weight) | Titanium oxide | 1 | |
| | Stabilizer | 0.5 | |

| | | |
|---|---|---|
| Mold temperature upon molding (° C.) | 100 | 130 |
| Adhesive performance | good | good |
| Sealing capability | good | good |

PVC, PPS, MBS and NBR in a “resin” row, and glass bead, antioxidant, titanium oxide and stabilizer (tributyl tin oxide) as additional components in Table 3 are the same as those in Examples 1-8.

Next, into a mold 13 in which a stainless plate (of SUS316) as the metal part 26a has been inserted (see FIG. 10), a resin compound shown in Table 3 is discharged, to thereby obtain the separator 44 and the separator 45 shown in FIG. 2. Temperatures of the mold upon molding (mold temperature) are shown in Table 3.

Next, with respect to the obtained separators 44, 45, adhesive performance between the resin part 26b and the metal part 26a shown in FIG. 2 was evaluated, as well as sealing capability of the separators 44, 45. The results are shown in Table 3.

Adhesive performance was evaluated by immersing the separators 44, 45 in hot water at 80° C. for 500 hours and by observing separation. The separator with no separation or lift between the resin part 26b and the metal part 26a is judges as good (indicated with “good” in Table 3).

For evaluation of sealing capability, the sealing part 17a (see FIGS. 3 and 5) was evaluated with respect to a stacked structure of the separator 44 and the separator 45, in which a flow passage 44s-side face of the separator 44 (see FIG. 3) and a flow passage 44s-side of the separator 45 (see FIG. 5) oppose to each other. The sealing linear pressure was made 5 kg/cm. An atmosphere at that time was 50% Rh at 23° C. In this evaluation of sealing capability the through-holes 44a, 44b, 44c, 44e and 44f of the separator 44 (see FIG. 3) were closed, and the through-holes 45a, 45b, 45c, 45d, 45e and 45f of the separator 45 (see FIG. 5) were also closed. Then, through the through-hole 44d and the communicating passage 44g (see FIG. 3), hydrogen was introduced between the separator 44 and the separator 45. At this time, the inner pressure of hydrogen purged between the separator 44 and the separator 45 was made 150 kPa.

After 10 minutes, the separator with a hydrogen pressure drop inside of 3% or less is judged as having excellent sealing capability (indicated with “good” in Table 3).

### Result of Evaluation Test

The separators 44, 45 obtained in Examples 9 and 10 exhibits excellent adhesive performance and sealing capability, as shown in Table 3.

What is claimed is:

1. A sealing member for a fuel cell comprising:
a resin forming a matrix phase, and
particles which are formed of rubber-like elastic body and dispersed in the resin.

2. The sealing member according to claim 1, wherein a content of the rubber-like elastic body is higher in an inner portion of the sealing member than in a surface portion.

3. The sealing member according to claim 1, wherein a content of the rubber-like elastic body in the whole sealing member is between 10 and 70 weight %.

4. The sealing member according to claim 2, wherein an entire surface of the sealing member is covered exclusively with the matrix phase.

5. The sealing member according to claim 1 formed of a single layer.

6. A method for producing a sealing member for a fuel cell, comprising:
a first step of heat-mixing a resin and particles formed of rubber-like elastic body to obtain a resin compound; and
a second step of injection molding of the resin compound into a mold.

7. A separator for a fuel cell comprising
a metal part in a shape of a plate provided with a gas flow passage on at least one side thereof, and
a resin part that has a sealing part formed of a protruding portion and is attached to the metal part,
wherein the resin part comprises a resin forming a matrix phase and particles formed of rubber-like elastic body dispersed in the resin.

8. The separator according to claim 7, wherein the resin part frames the metal part in a plane direction and the sealing part is disposed around the metal part.

9. The separator according to claim 7,
wherein the resin part has
at least one of a supply hole for reaction gas, an exhaust hole for reaction gas, a supply hole for cooling water and a drain hole for cooling water, and
a flow passage for reaction gas or cooling water connecting the hole and the metal part, and
wherein the sealing part is disposed around the hole and around the flow passage formed in the resin part.

10. The separator according to claim 7, wherein the resin part is unified with the metal part.
